(19) United States
(12) Patent Application Publication
(10) Pub. No.: US 2024/0147543 A1
(43) Pub. Date: May 2, 2024

(54) TERMINAL AND RADIO COMMUNICATION METHOD

(71) Applicant: NTT DOCOMO, INC., Tokyo (JP)

(72) Inventor: Tianyang Min, Tokyo (JP)

(73) Assignee: NTT DOCOMO, INC., Tokyo (JP)

(21) Appl. No.: 18/547,941

(22) PCT Filed: Feb. 26, 2021
(86) PCT No.: PCT/JP2021/007326

§ 371 Date: Aug. 25, 2023

(51) Int. Cl. H04W 74/0833; H04W 76/15

(52) U.S. Cl. CPC H04W 74/0833; H04W 76/15

(57) ABSTRACT

A terminal receives a message including a reconfiguration instruction of the secondary cell group. When the secondary cell group is in an inactive state and the secondary cell is added or changed, the terminal stops the random access procedure for a prescribed time even if the secondary cell is reconfigured based on the reconfiguration instruction.

### TECHNICAL FIELD

The present disclosure relates to a terminal and radio communication method that support dual connectivity.

### BACKGROUND ART

3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

For example, in Release-17 of 3GPP, expansion of Multi-RAT Dual Connectivity (MR-DC) is being considered (Non-Patent Literature 1). Specifically, support for an efficient activation/deactivation mechanism for a secondary cell group (SCG) and a secondary cell (SCell) is addressed.

In addition, with regard to support for such an SCG activation/deactivation mechanism, some proposals have been made for handling reconfiguration during handover of a deactivated SCG, specifically reconfiguration with sync (see Non-Patent Literature 2).

### CITATION LIST

### Non-Patent Literature

Non-Patent Literature 1 “Revised WID on Further Multi-RAT Dual-Connectivity enhancements”, RP-201040, 3GPP TSG RAN Meeting #88 e, 3GPP, June 2020

Non-Patent Literature 2 “Mobility and RRM for deactivated SCG”, R2-2101094, 3GPP TSG-RAN WG2 meeting #113 e, 3GPP, January 2021

### SUMMARY OF INVENTION

In Non-Patent Literature 2 described above, considering that the SCG is deactivated, a method has been proposed in which the primary SCell (PSCell) and random access (RA) procedures are not immediately executed even when the terminal (User Equipment, UE) receives a message (Specifically, RRC Reconfiguration) of the radio resource control layer (RRC).

In addition, upon PSCell addition/change, when the UE executes reconfigurationWithSync, it also resets the settings of the medium access control layer (MAC).

Therefore, resources for the random access channel (RACH) held by the UE may be wasted.

Accordingly, the following disclosure has been made in view of such a situation, and it is an object of the present invention to provide a terminal and a radio communication method capable of efficiently utilizing resources for RACH even when adding or changing a PSCell in a deactivated SCG (SCG).

One aspect of the present disclosure is a terminal (UE 200) including a reception unit (RRC processing unit 220) that receives a message including a reconfiguration instruction for a secondary cell group, and a control unit (control unit 240) that, when adding or changing a secondary cell while the secondary cell group is in an inactive state, even if reconfiguration of the secondary cell is executed based on the reconfiguration instruction, stops a random access procedure for a prescribed period of time.

One aspect of the present disclosure is a terminal (UE 200) including a reception unit (RRC processing unit 220) that receives a message including a reconfiguration instruction for a secondary cell group, and a control unit (control unit 240) that, when adding or changing a secondary cell while the secondary cell group is in an inactive state, executes a random access procedure based on the reconfiguration instruction and maintains the secondary cell group in an inactive state.

One aspect of the present disclosure is a terminal (UE 200) including a reception unit (RRC processing unit 220) that receives a message including a reconfiguration instruction for a secondary cell group, and a control unit (control unit 240) that, when adding or changing a secondary cell while the secondary cell group is an inactive state, executes only a part of the reconfiguration of the secondary cell based on the reconfiguration instruction and stops a random access procedure.

One aspect of the present disclosure is a terminal (UE 200) including a reception unit (RRC processing unit 220) that receives a message including a reconfiguration instruction for a secondary cell group, and a control unit (control unit 240) that, when adding or changing a secondary cell while the secondary cell group is in an inactive state, if activation of the secondary cell group is required after receiving the reconfiguration instruction, executes reconfiguration of the secondary cell based on the reconfiguration instruction.

One aspect of the present disclosure is a radio communication method including the steps of receiving, by a terminal, a message containing a reconfiguration instruction for a secondary cell group, and when the terminal adds or changes a secondary cell while the secondary cell group is in an inactive state, even if the terminal executes reconfiguration of the secondary cell based on the reconfiguration instruction, stopping the random access procedure for a prescribed period of time.

One aspect of the present disclosure is a radio communication method including the steps of receiving, by a terminal, a message containing a reconfiguration instruction for a secondary cell group, and when the terminal adds or changes a secondary cell while the secondary cell group is in an inactive state, executing only a part of the reconfiguration of the secondary cell based on the reconfiguration instruction and stopping the random access procedure.

### BRIEF DESCRIPTION OF DRAWINGS

FIG. 1 is an overall schematic configuration diagram of radio communication system 10.

FIG. 2 is a functional block diagram of the eNB 100 A.

FIG. 3 is a functional block diagram of the UE 200.

FIG. 4 is a diagram showing an example of a communication sequence related to PSCell addition/change.

FIG. 5 is a diagram showing a reconfigurationWithSync-related operation flow of the UE 200 according to the operation example 1.

FIG. 6 is a diagram showing an operation flow of the UE 200 when a trigger requiring activation of the SCG occurs.

FIG. 7 is a diagram showing a reconfigurationWithSync-related operation flow of the UE 200 according to the operation example 2.

FIG. 8 is a diagram showing a reconfigurationWithSync-related operation flow of the UE 200 according to the operation example 3.

FIG. 9 is a diagram showing a reconfigurationWithSync-related operation flow of the UE 200 according to the operation example 4.

FIG. 10 is a diagram showing an example of the procedure of Reconfiguration with sync.

FIG. 11 is a diagram showing an example of a hardware configuration of the eNB 100 A, the gNB 100 B and the UE 200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### (1) Overall Schematic Configuration of the Radio Communication System

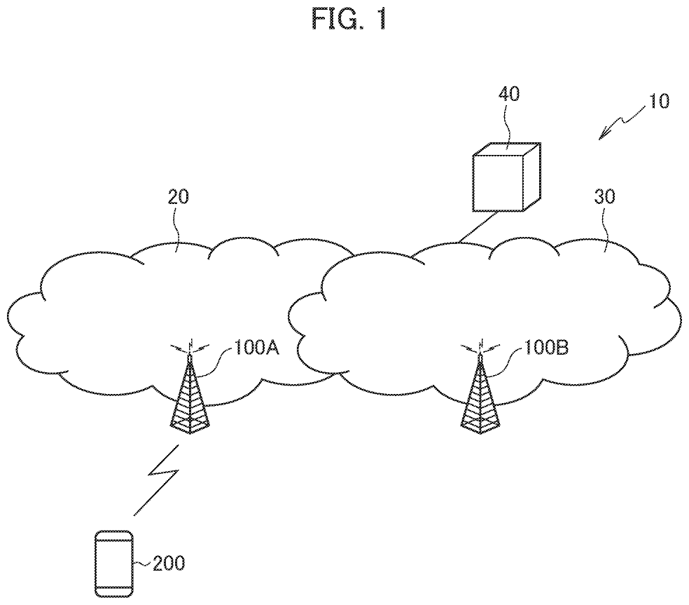

FIG. 1 is an overall schematic configuration diagram of a radio communication system 10 according to this embodiment. The radio communication system 10 is radio communication system according to Long Term Evolution (LTE) and 5G New Radio (NR). Note that LTE may be referred to as 4G and NR may be referred to as 5G. The radio communication system 10 may also be a radio communication system following a scheme called Beyond 5G, 5G Evolution or 6G.

LTE and NR may be interpreted as radio access technologies (RAT), and in this embodiment, LTE may be referred to as a first radio access technology and NR may be referred to as a second radio access technology.

The radio communication system 10 includes the Evolved Universal Terrestrial Radio Access Network 20 (E-UTRAN 20) and the Next Generation-Radio Access Network 30 (hereinafter NG RAN 30). The radio communication system 10 also includes a terminal 200 (UE 200, User Equipment).

The E-UTRAN 20 includes an eNB 100 A which is a radio base station according to LTE. NG RAN 30 includes gNB 100 B which is a radio base station in accordance with 5 G (NR). The NG RAN 30 is connected to a User Plane Function 40 (hereinafter, UPF 40) which is included in the system architecture of 5G and provides user plane functions. The E-UTRAN 20 and the NG RAN 30 (which may be eNB 100 A or gNB 100 B) may simply be referred to as a network.

The eNB 100 A, the gNB 100 B, and the UE 200 can support carrier aggregation (CA) using a plurality of component carriers (CCs), dual connectivity for simultaneously transmitting component carriers between a plurality of NG-RAN nodes and the UE, and the like.

The eNB 100 A, gNB 100 B and UE 200 perform radio communication via a radio bearer, specifically, a Signalling Radio Bearer (SRB) or a DRB Data Radio Bearer (DRB).

In this embodiment, the eNB 100 A may configure the master node (MN) and the gNB 100 B may configure the secondary node (SN) by executing Multi-Radio Dual Connectivity (MR-DC), specifically E-UTRA-NR Dual Connectivity (EN-DC), or the gNB 100 B may configure the MN and the eNB 100 A may configure the SN by executing NR-E-UTRA Dual Connectivity (NE-DC). Alternatively, NR-NR Dual Connectivity (NR-DC) in which the gNB constitutes the MN and SN may be executed.

As described above, the UE 200 supports dual connectivity connecting the eNB 100 A and the gNB 100 B.

The eNB 100 A is included in the master cell group (MCG), and the gNB 100 B is included in the secondary cell group (SCG). That is, the gNB 100 B is an SN included in the SCG.

The eNB 100 A and gNB 100 B may be referred to as radio base stations or network devices.

In addition, radio communication system 10 may support the addition or change of Primary SCell (PSCell). The PSCell addition/change may include a conditional PSCell addition/change.

PSCell is a type of secondary cell. PSCell means Primary SCell (secondary cell), and it may be interpreted that any SCell among a plurality of SCells corresponds to it.

The secondary cell may be read as a secondary node (SN) or a secondary cell group (SCG).

The radio communication system 10 may also support conditional inter-SN PSCell change procedures. Specifically, MN-initiated conditional inter-SN PSCell change and/or SN-initiated conditional inter-SN PSCell change may be supported.

### (2) Function Block Configuration of Radio Communication System

Next, the functional block configuration of radio communication system 10 will be described. Specifically, the functional block configurations of the eNB 100 A and the UE 200 will be described.

### (2.1) eNB 100A

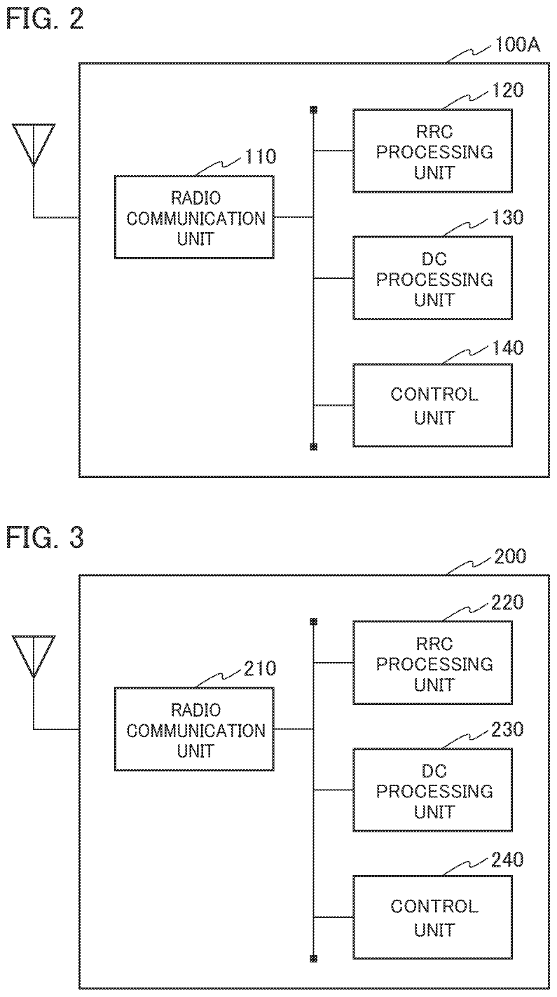

FIG. 2 is a functional block diagram of the eNB 100 A. As shown in FIG. 2, the eNB 100 A includes a radio communication unit 110, an RRC processing unit 120, a DC processing unit 130, and a control unit 140. Although the gNB 100 B also supports NR, it may have the same function as the eNB 100 A.

The radio communication unit 110 transmits a downlink signal (DL signal) in accordance with LTE. The radio communication unit 110 receives an uplink signal (UL signal) in accordance with LTE.

The radio communication unit 110 assembles/disassembles PDUs/SDUs in a plurality of layers (Media access control layer (MAC), radio link control layer (RLC), and packet data convergence protocol layer (PDCP), etc.).

The RRC processing unit 120 executes various processes in the radio resource control layer (RRC). Specifically, the RRC processing unit 120 can transmit the RRC Reconfiguration to the UE 200. The RRC processing unit 120 can receive the RRC Reconfiguration Complete, which is a response to the RRC Reconfiguration, from the UE 200.

In this embodiment, the eNB 100 A supports LTE, but in this case, the name of the RRC message may be RRC Connection Reconfiguration or RRC Connection Reconfiguration Complete.

Also, the RRC Reconfiguration (and inter-node RRC messages) between the MN and SN may include reconfigurationWithSync (reconfiguration instruction) relating to the reconfiguration of the cell. reconfigurationWithSync is specified, for example, in Section 3GPP TS 38.331 5.3.5.5.2.

reconfigurationWithSync may be interpreted as a common mechanism to activate (That is, add NR cells) a cell (NR cell) in a non-standalone (NSA) containing other RATs (such as LTE). Although the UE 200 can perform random access procedures (RA procedures) and the like based on reconfigurationWithSync, specific operations based on reconfigurationWithSync will be described later.

The DC processing unit 130 executes processing related to dual connectivity, specifically, Multi-RAT Dual Connectivity (MR-DC). In this embodiment, since the eNB 100 A supports LTE and the gNB 100 B supports NR, the DC processing unit 130 may execute processing related to E-UTRA-NR Dual Connectivity (EN-DC). The type of DC is not limited as described above, and may correspond to, for example, NR-E-UTRA Dual Connectivity (NE-DC) or NR-NR Dual Connectivity (NR-DC).

The DC processing unit 130 can transmit/receive a message specified in the 3 GPP TS 37.340 or the like, and execute processing related to setting and releasing DC between the eNB 100 A, the gNB 100 B and the UE 200. The control unit 140 controls each functional block constituting the eNB 100 A. In particular, in this embodiment, the control unit 140 performs control regarding the addition or modification of a secondary cell (which may be a secondary node).

Specifically, control unit 140 can perform control regarding the secondary cell group (SCG) as active/de-active. Specifically, the control unit 140 may activate (may be referred to as activating) or deactivate (may be referred to as deactivating) the SCG. More specifically, control unit 140 may activate or deactivate one or more SCells (May contain PSCell) contained in the SCG.

An active SCG (SCell) may be interpreted as a state in which the UE 200 can immediately use the SCG (SCell). The inactive SCG (SCell) may be interpreted as a state in which the UE 200 cannot immediately use the SCG (SCell), but the setting information is retained.

In this embodiment, the channel includes a control channel and a data channel. The control channels include PDCCH (Physical Downlink Control Channel), PUCCH (Physical Uplink Control Channel), PRACH (Physical Random Access Channel), PBCH (Physical Broadcast Channel), and the like.

The data channels include PDSCH (Physical Downlink Shared Channel) and PUSCH (Physical Uplink Shared Channel).

The reference signals include a Demodulation reference signal (DMRS), a Sounding Reference Signal (SRS), a Phase Tracking Reference Signal (PTRS), and a Channel State Information-Reference Signal (CSI-RS). The data may refer to data transmitted via a data channel.

### (2.2) UE 200

FIG. 3 is a functional block diagram of the UE 200. As shown in FIG. 3, the UE 200 includes a radio communication unit 210, an RRC processing unit 220, a DC processing unit 230, and a control unit 240.

The radio communication unit 210 transmits an uplink signal (UL signal) in accordance with LTE or NR. The radio communication unit 210 receives a downlink signal (DL signal) in accordance with LTE or NR. That is, the UE 200 can access the eNB 100 A (E-UTRAN 20) and the gNB 100 B (NG RAN 30), and can support dual connectivity (Specifically, EN-DC).

Similar to the radio communication unit 110 of the eNB 100 A (gNB 100 B), the radio communication unit 210 performs assembly/disassembly of the PDU/SDU in the MAC, RLC, PDCP, etc.

The RRC processing unit 220 executes various processes in the radio resource control layer (RRC). Specifically, the RRC processing unit 220 can transmit and receive messages of the radio resource control layer.

More specifically, the RRC processing unit 220 can receive the RRC Reconfiguration transmitted from the network (eNB 100 A or gNB 100 B). The RRC processing unit 220 can transmit the RRC Reconfiguration Complete, which is a response to the RRC Reconfiguration, to the network.

As noted above, the RRC Reconfiguration may include reconfigurationWithSync. The reconfigurationWithSync is an information element (IE) relating to the reconfiguration of a cell, and can be broadly interpreted as a reconfiguration instruction of a cell group, specifically, an MCG or SCG. In the present embodiment, the RRC processing unit 220 may configure a reception unit for receiving a message including an instruction to reset the SCG.

Reconfiguration with key change and reconfiguration without key change may be specified in reconfigurationWithSync. In Reconfiguration with sync and key change (Type 1), at least one of the following operations may be performed.
Performing RA Steps to PSCell
Reset MAC
Reestablishing the RLC
Reestablishing the PDCP
SCG Security Updates

In Reconfiguration with sync but without key change (Type 2), at least one of the following operations may be performed.
Performing RA Steps to PSCell
Reset MAC
Reestablishing the RLC
PDCP data recovery (for Acknowledged Mode (AM) DRB)

The DC processing unit 230 executes processing related to dual connectivity, specifically, MR-DC. As described above, in the present embodiment, the DC processing unit 230 may execute processing relating to EN-DC, but may correspond to NE-DC and/or NR-DC.

The DC processing unit 230 accesses the eNB 100 A and the gNB 100 B, respectively, and can execute setting in a plurality of layers (Media access control layer (MAC), radio link control layer (RLC), and packet data convergence protocol layer (PDCP), etc.) including RRC.

The control unit 240 controls each functional block constituting the UE 200. In particular, in this embodiment, the control unit 240 can perform control regarding the activation/de-activation of the secondary cell group (SCG).

Specifically, the control unit 240 may operate as follows when adding or modifying secondary cells while the SCG is in an inactive state. The secondary cell may be a PSCell or a normal SCell. The SCG is in an inactive state, which may be interpreted as the secondary cell (or SN) being in an inactive state.

The control unit 240 may cancel the RA procedure for a specified period of time even if it performs a reconfiguration of the SCell (PSCell) based on reconfigurationWithSync. Specifically, control unit 240 may cause the RRC processing unit 220 to perform the above-described operation based on the reconfigurationWithSync, but may not immediately execute the RA procedure with the target PSCell (transmit the RACH), and may release the dedicated RACH resource held when the predetermined time has elapsed.

The specified time may be a setting time of the timer T 304 or a setting time of a new timer (Refer to as T3xx for convenience). Timer T 304 may be started upon receipt of an RRC Reconfiguration message containing reconfigurationWithSync, or upon performing a conditional reconfiguration, i.e., upon application of a stored RRC Reconfiguration message containing reconfigurationWithSync, and stopped upon successful completion of random access on the corresponding Special Cell (SpCell).

The control unit 240 may also perform an RA procedure based on reconfigurationWithSync to keep the SCG in an inactive state. Specifically, the control unit 240 may cause the RRC processing unit 220 to immediately perform the above-described operation based on the reconfigurationWithSync, but may keep the SCG (which may be interpreted as a PSCell or a SCell) in an inactive state even after the operation.

Alternatively, the control unit 240 may perform only a portion of the reconfiguration of the SCell (PSCell) based on reconfigurationWithSync and abort the RA procedure. Specifically, the control unit 240 may cause the RRC processing unit 220 to execute the above-described operation based on the reconfigurationWithSync, but may not immediately execute the RA procedure with the target PSCell (transmit the RACH), and may not execute the MAC-reset and subsequent operations. Details of the operation executed after the MAC reset will be described later.

Alternatively, after receiving the reconfigurationWithSync, the control unit 240 may perform a reconfiguration of the SCell (PSCell) based on the reconfigurationWithSync when activation of the SCG is required. More specifically, when the control unit 240 receives the reconfigurationWithSync, it is not necessary for the RRC processing unit 220 to immediately execute the above-described operation.

When a trigger (UE activation trigger) requiring activation of the SCG occurs in the UE 200 (such as when data remaining in a buffer inside the UE 200 occurs) or when an activation instruction (NW activation indication) is received from the network (RRC messages, MAC-CE (Control Element) or Layer 1 signaling), the control unit 240 may cause the RRC processing unit 220 to execute the above-described operation based on reconfigurationWithSync.

### (3) Operation of Radio Communication System

Next, the operation of radio communication system 10 will be described. Specifically, an operation related to the activation/de-activation of the secondary cell group (SCG) will be described.

### (3.1) Assumptions

The 3GPP considers support for efficient activation/deactivation mechanisms for SCG and SCell (which may include PSCell). It is agreed that the SCG activation state can be configured at the time of PSCell addition/change, RRC resume or handover (HO).

The SCG may be in at least one of the following states.
No PUSCH is sent on the deactivated SCG.
PDCCH is not monitored in PSCell of deactivated SCG.
SCell dormancy is not supported for SCells in a deactivated SCG.
The UE 200 maintains the synchronization state of the DL.
UE 200 performs Restricted RRM measurement.
PSCell mobility is supported.
The UE 200 performs limited radio link monitoring (RLM) and/or does not perform beam management (beam failure detection and recovery), SRS (Sounding Reference Signal) transmission, or CSI report.

In addition, the following ideas are being considered for actions based on reconfiguration with sync for SCG.
(Proposal 1): Only active can be configured as the target SCG activation state. The UE 200 may perform reconfiguration with sync for the SCG and PSCell random access as before.
Proposal 1 is the simplest approach and the network may explicitly deactivate the SCG after handover, if necessary.
Proposal 2: The target SCG activation state can be configured to either inactive or active. The UE 200 may perform a PSCell random access even if the target SCG activation state is configured to inactive in reconfigurationWithSync, but the PSCell random access may not imply SCG activation.
Proposal 3: The target SCG activation state can be configured to either inactive or active. The UE 200 may perform a PSCell random access if the target SCG activation state is configured to active in reconfigurationWithSync for the SCG. On the other hand, the UE 200 need not perform PSCell random access if the target SCG activation state is configured to inactive in the reconfigurationWithSync for the SCG (However, other actions such as a MAC reset of the SCG). PSCell random access may be performed at a later stage (For example, when random access is required for SCG activation, the time of SCG activation).
Proposal 4: The target SCG activation state can be configured to either inactive or active. The UE 200 may perform reconfigurationWithSync for the SCG and PSCell random access if the target SCG activation state is configured to active. On the other hand, the UE 200 may not perform reconfigurationWithSync for the SCG if the target SCG activation state is configured to inactive.

However, reconfigurationWithSync for the SCG and PSCell random access may be performed at a later stage (For example, at the time of SCG activation). Proposal 4 is also a simple approach, and at least activation of the SCG may be performed using reconfigurationWithSync for the SCG.

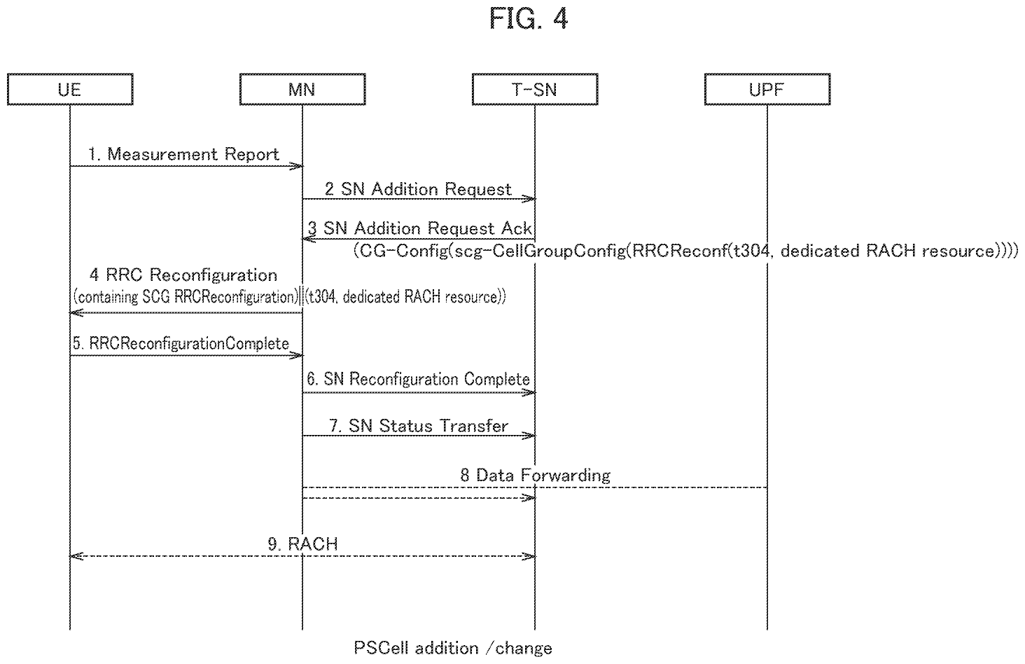

FIG. 4 shows an example of a communication sequence related to PSCell addition/change. As shown in FIG. 4, when the MN transmits the RRC Reconfiguration to the UE 200 in the PSCell addition/change (adding or changing the PSCell), the RRC Reconfiguration includes the SCG RRC Reconfiguration. The SCG RRC Reconfiguration may include an information element such as reconfigurationWithSync.

reconfigurationWithSync contains parameters for T 304 and Dedicated RACH resource. Timer T 304 may be started upon receipt of an RRC Reconfiguration message containing reconfigurationWithSync or upon execution of a PSCell addition/change, that is, upon application of an RRC Reconfiguration message containing reconfigurationWithSync, and stopped upon successful completion of random access on the corresponding Special Cell (SpCell).

As with 3 GPP Releases 15 and 16, in a PSCell addition/change, when a radio base station (For example, gNB 100 B) transmits an RRC Reconfiguration to the UE 200, the UE 200 must immediately perform an RA procedure with the target PSCell, that is, transmit a RACH.

For 3 GPP Release 17, the SCG activation state can now be configured to inactive in PSCell addition/change. Thus, the UE 200 may execute the RA procedure with the target PSCell immediately, that is, transmit the RACH at a later stage without necessarily transmitting the RACH (see Proposals 3 and 4 described above).

However, in view of the above proposal regarding the operation based on reconfiguration with sync for SCG, there are the following problems regarding PSCell addition/change of deactivated SCG.
Issue 1: In 3 GPP Release 15, 16, reconfigurationWithSync fails (t 304 expiry) and the dedicated RACH resource is released if the RACH is not completed before the timer T 304 expires. For 3 GPP Release 17, if UE 200 continues to hold dedicated RACH resources without executing RACH, it will waste RACH resources.
Issue 2: In 3 GPP Releases 15 and 16, when UE 200 operates on reconfigurationWithSync in a PSCell addition/change, the MAC is also reset, as described above. When the MAC is reset, the dedicated RACH resource is discarded. Therefore, in the above-mentioned (Proposal 3), it may be meaningless to configure the dedicated RACH resource. That is, when the SCG is in an inactive state, it is unclear which operation (procedure) of a series of operations based on reconfigurationWithSync should be executed.

### (3.2) Example of Operation

Hereinafter, an operation example capable of solving the above-described problem 1 or problem 2 will be described. Specifically, the operation example 1˜4 will be described. The operation examples 1 and 2 correspond to the problem 1, and the operation examples 3 and 4 correspond to the problem 2.

Each operation example assumes a case in which the state of SCG (PSCell) is configured to “deactivated” at the time of PSCell addition/change.

### (3.2.1) Operation Example 1

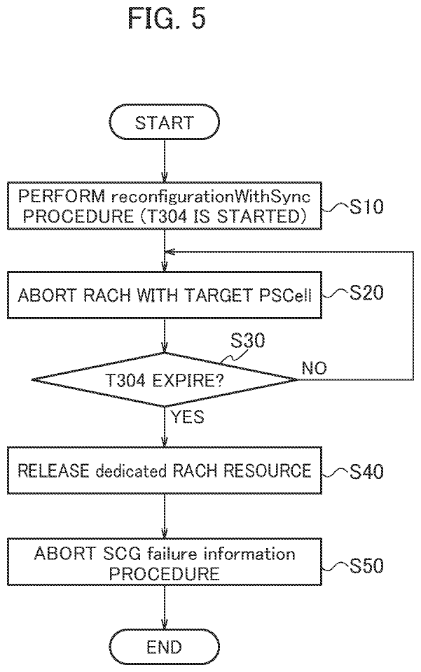

FIG. 5 shows a reconfigurationWithSync-related operation flow of the UE 200 according to the operation example 1. As shown in FIG. 5, the UE 200 performs a procedure based on reconfigurationWithSync (S 10). Specifically, the UE 200 performs operations based on the reconfigurationWithSync described above. Timer T 304 is started (started) when reconfigurationWithSync is received.

However, the UE 200 may abort the RA procedure with the target PSCell, that is, the RACH transmission (step 20). That is, the UE 200 does not need to send a RACH to the target PSCell immediately upon receiving reconfigurationWithSync.

If timer T 304 expires, UE 200 may release the dedicated RACH resource (Sections 30 and 40). The UE 200 may also abort the SCG failure information procedure even if the timer T 304 has expired, that is, the random access has not been completed (S 50). Note that only one of the processes in S 40 and S 50 may be executed.

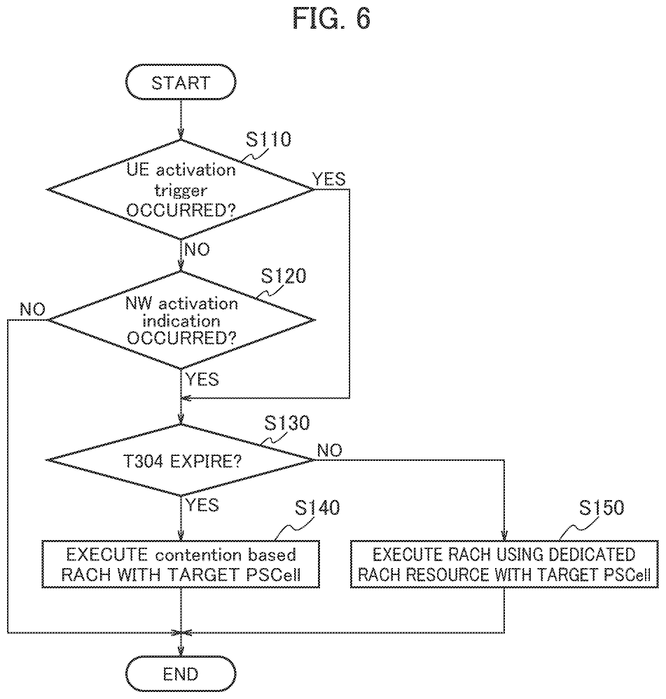

The UE 200 according to the operation example 1 may further operate as follows. FIG. 6 shows an operation flow of the UE 200 when a trigger requiring activation of the SCG occurs.

As shown in FIG. 6, the UE 200 determines whether or not a trigger (UE activation trigger) requiring activation of the SCG has occurred in the UE 200 (step 110). As described above, the UE activation trigger may be a case where data remaining in a buffer inside the UE 200 occurs and the DRB must be configured via a secondary cell.

In addition, the UE 200 determines whether or not an activation instruction (NW activation indication) has occurred from the network (S 120). Specifically, the UE 200 may receive the activation indication via an RRC message, MAC-CE (Control Element) or Layer 1 signaling.

The UE 200 determines whether or not the timer T 304 has expired (step 130). T 304 can be configured to a minimum of 50 ms and a maximum of 10,000 ms (10 seconds).

The UE 200 may access the target PSCell in accordance with the contention based RA procedure when the timer T 304 expires (S 140). That is, the UE 200 may execute the contention based RACH with the target PSCell.

On the other hand, if the timer T 304 has not expired, the UE 200 may execute a RACH with the target PSCell using the dedicated RACH resource it holds (S 150).

Instead of using T 304, a new timer (T3xx) may be provided. As shown in Table 1, T3xx is a timer that manages the retention of dedicated RACH resources when the state of the SCG (PSCell) is configured to deactivated at the time of PSCell addition/change, and when the timer expires, the dedicated RACH resource may be discarded.

TABLE 1

| Timer | Start | Stop | At expiry |
|---|---|---|---|
| T3xx | Upon reception of | Upon successful | Release the |
| | RRCReconfiguration | completion | dedicated |
| | message including | of random | RACH |
| | ReconfigurationWithSync or | access on the | resource. |
| | ReconfigurationWithSCGDeactivated | corresponding | |
| | in which rach-configdedicated is | SpCell | |
| | configured. | For T3xx of | |
| | | SCG, upon | |
| | | SCG release | |

The contents of ReconfigurationWihSCG Deactivated may consist of sPcellConfigCommon, newUE-Indentity, T3xx, rach-ConfigDedicated, smtc (SSB based RRM Measurement Timing Configuration window).

The timer T 304 has a maximum time of 10 seconds, but a larger value (For example, one minute) may be configured for the timer T 3 xx. For example, T3xx may be defined as follows.

t3xx ENUMERATED {ms1000, ms2000, ms10000, ms15000, ms20000, ms25000, ms30000, ms60000},

### (3.2.2) Example 2

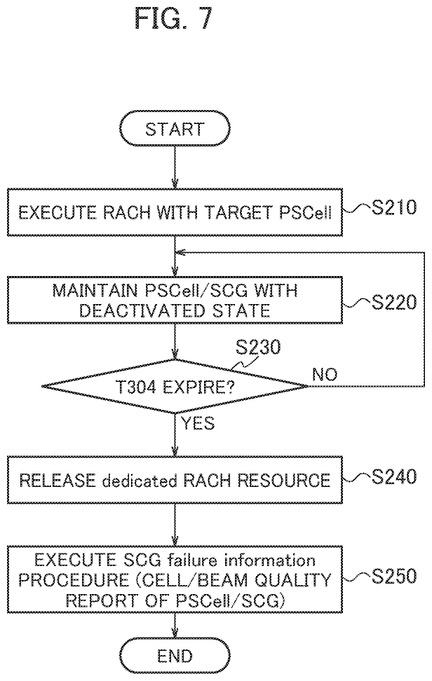

FIG. 7 shows a reconfigurationWithSync-related operation flow of the UE 200 according to the operation example 2. As shown in FIG. 7, the UE 200 may execute an RA procedure, or RACH transmission, with the target PSCell immediately upon receipt of the reconfigurationWithSync (S 210). It is to be noted that immediate means may be interpreted as immediately after the reconfiguration with sync is received, that is, an intentional delay is not configured by using a timer or the like, but a slight delay that may occur in processing may be permitted.

The UE 200 executes the RA procedure with the target PSCell, but maintains the state of the SCG (PSCell) at deactivated (S 220) thereafter, and determines whether or not the timer T 304 has expired (S 230).

The UE 200 may release the dedicated RACH resource if the timer T 304 expires (S 240). The UE 200 executes the SCG failure information procedure (step 250). Here, the UE 200 may configure the failure cause to “SCGFailureWithDeactivatedState” and report the cell quality and/or beam quality of the deactivated SCG (PSCell).

In this operation example, the UE 200 may operate as follows. Specifically, the UE 200 may change the state of the SCG (PSCell) to the active state once after executing the RA procedure with the target PSCell, in place of maintaining the state of the SCG (PSCell) to the deactivated state (S 220), but may change the state to the inactive state immediately thereafter (without delay).

Alternatively, after executing the RA procedure with the target PSCell, the state of the SCG (PSCell) may be changed to the active state, but may be changed to the inactive state if a specific timer started at the time of the change expires.

If a UE activation trigger or NW activation indication occurs after the state of the SCG (PSCell) is changed to the inactive state but before the time AlignmentTimer (TA timer) expires, the UE 200 may omit the RACH transmission (RA procedure) and activate the SCG (PSCell). If the timeAlignmentTimer expires, the UE 200 may access the target PSCell according to the contention based RA procedure.

### (3.2.3) Example 3

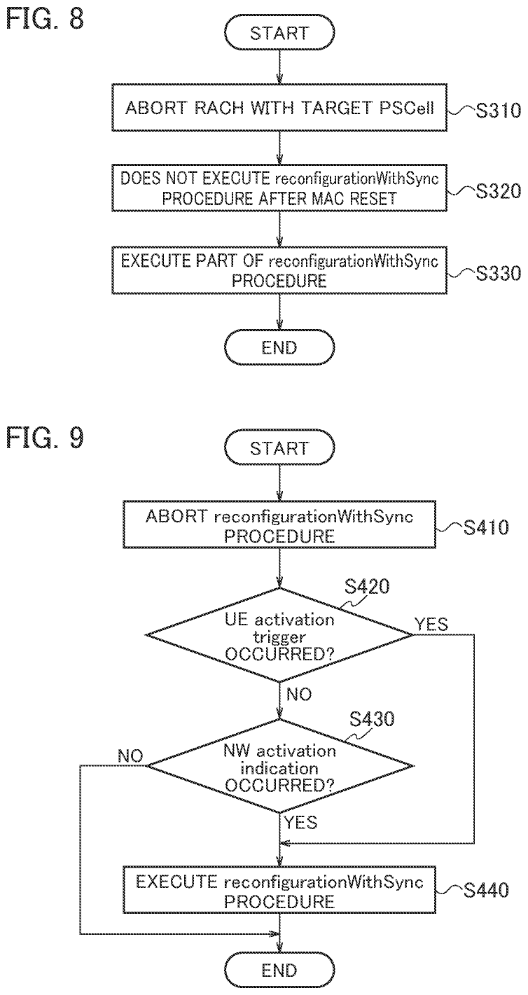

FIG. 8 shows a reconfigurationWithSync-related operation flow of the UE 200 according to the operation example 3. As shown in FIG. 8, the UE 200 may stop executing the RA procedure with the target PSCell, that is, the RACH transmission (step 310). Specifically, the UE 200 performs an operation (procedure) according to reconfigurationWithSync, but does not need to immediately send a RACH to the target PSCell.

The UE 200 does not execute the reconfigurationWithSync procedure after the MAC reset and the MAC reset in the reconfigurationWithSync procedure (S 320).

The UE 200 may also perform some of the reconfigurationWithSync procedures (S 330). Specifically, of the Reconfiguration with Sync procedure specified in Section 5.3.5.5.2 of 3GPP TS 38.331, the UE 200 may execute processing prior to “1>else: . . . ” immediately before the MAC reset, and may not execute processing subsequent to the MAC reset after “1>else: . . . ”.

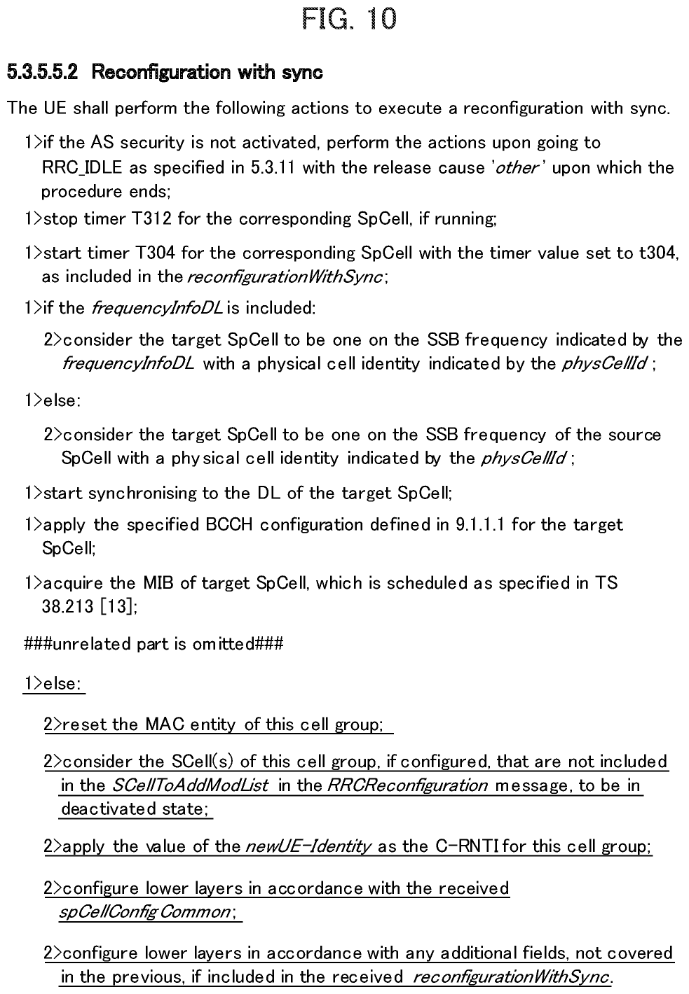

FIG. 10 shows an example of the Reconfiguration with Sync procedure. As shown in FIG. 10, the UE 200 may execute processing prior to “1>else: . . . ” immediately before “2>reset the MAC entity of this cell group;”, and may not execute processing after “2>reset the MAC entity of this cell group; ” (see the underlined portion).

Specifically, the UE 200 need not reset the MAC entity, apply the newUE-Identity as a C-RNTI (Cell-Radio Network Temporary Identifier), configure a lower layer according to the received spCellConfigCommon, etc.

Note that the reset of the MAC may mean the reset of the MAC entity as described above, and when the reset is requested by the upper layer, the MAC entity may discard the random access resource without conflict, that is, the dedicated RACH resource.

If a trigger requiring activation of the SCG occurs after the processing up to step 330, the UE 200 may operate in accordance with the flow shown in FIG. 6. Also in this case, a new timer (T3xx) may be provided instead of diverting T 304.

### (3.2.4) Example 4

FIG. 9 shows a reconfigurationWithSync-related operation flow of the UE 200 according to the operation example 4. As shown in FIG. 9, the UE 200 may abort the reconfigurationWithSync procedure even when performing a PSCell addition/change (S 410). Specifically, the UE 200 may not immediately perform the reconfigurationWithSync procedure, even when performing a PSCell addition/change.

The UE 200 determines whether or not a trigger (UE activation trigger) requiring activation of the SCG has occurred in the UE 200 (S 420). The processing is the same as that in step 110 shown in FIG. 6.

In addition, the UE 200 determines whether or not an activation instruction (NW activation indication) has occurred from the network (S 430). The processing is the same as that in step 120 shown in FIG. 6.

If a UE activation trigger or NW activation indication occurs, UE 200 may perform the aborted reconfigurationWithSync procedure (S 440). Specifically, the UE 200 may perform the Reconfiguration with Sync procedure specified in Section 3GPP TS 38.331 5.3.5.5.2 shown in FIG. 10.

### (4) Operational Effects

According to the embodiment described above, the following effects are obtained. Specifically, if the SCG is in an inactive state and adds or modifies a SCell (PSCell), the UE 200 may perform a reconfiguration of the SCell (PSCell) based on reconfigurationWithSync, but abort the RA procedure for a specified period of time. Alternatively, the UE 200 may perform an RA procedure based on reconfigurationWithSync to keep the SCG in an inactive state.

Therefore, the RACH timing in the case of PSCell addition/change with respect to the deactivated SCG and the timing of releasing the dedicated RACH resource become clear, and the quick activation of the SCG and the efficient utilization of the dedicated RACH resource can be made compatible.

In the present embodiment, when adding or changing a SCell (PSCell) while the SCG is inactive, the UE 200 may perform only a part of the reconfiguration of the SCell (PSCell) based on the reconfigurationWithSync and abort the RA procedure. Alternatively, the UE 200 may reconfigure the SCell (PSCell) based on the reconfigurationWithSync when the activation of the SCG is required after receiving the reconfigurationWithSync.

Therefore, when the UE 200 activates the deactivated SCG, the UE can properly perform the necessary operations of the reconfigurationWithSync procedure. As a result, the UE 200 and radio communication system 10 as a whole can be operated efficiently.

### (5) Other Embodiments

Although the embodiment has been described above, it is obvious to those skilled in the art that various modifications and improvements are possible without being limited to the description of the embodiment.

For example, in the above embodiment, EN-DC in which MN is eNB and SN is gNB has been described as an example, but other DC may be used as described above. Specifically, it may be NR-DC where MN is gNB and SN is gNB, or NE-DC where MN is gNB and SN is eNB.

SCG deactivation may also be replaced by other terms of a similar meaning, such as deactivation, dormancy, and the like described above.

Further, the block configuration diagrams (FIGS. 2 and 3) used for the description of the above-described embodiment show blocks in units of functions. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that functions the transmission is called a transmission unit (transmitting unit) or a transmitter. As described above, there is no particular limitation on the method of implementation.

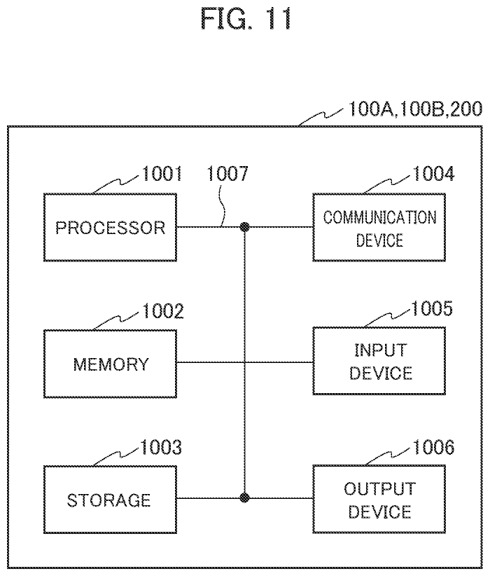

Further, the above-mentioned eNB 100 A, gNB 100 B and UE 200 (the apparatus) may function as a computer that performs processing of the radio communication method of the present disclosure. FIG. 11 is a diagram showing an example of a hardware configuration of the apparatus. As shown in FIG. 11, the device may be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIG. 2.3) is implemented by any hardware element or combination of hardware elements of the computer device.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001 operates, for example, an operating system to control the entire computer. Processor 1001 may comprise a central processing unit (CPU) including interfaces to peripheral devices, controllers, arithmetic units, registers, and the like.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. Memory 1002 may be referred to as a register, cache, main memory, or the like. The memory 1002 may store programs (program codes), software modules, and the like that are capable of executing the method according to one embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Devices such as the processor 1001 and the memory 1002 are connected by a bus 1007 for communicating information. The bus 1007 may be configured using a single bus or may be configured using different buses for each device.

In addition, the device may comprise hardware such as a microprocessor, a digital signal processor (DSP), an application specific integrated circuit (ASIC), a programmable logic device (PLD), a field programmable gate array (FPGA), and the hardware may implement some or all of each functional block. For example, the processor 1001 may be implemented by using at least one of these hardware.

Further, the notification of the information is not limited to the mode/embodiment described in the present disclosure, and other methods may be used. For example, notification of information may be performed by physical layer signaling (e.g., Downlink Control Information (DCI), Uplink Control Information (UCI), higher layer signaling (e.g., RRC signaling, Medium Access Control (MAC) signaling, broadcast information (Master Information Block (MIB), System Information Block (SIB)), other signals, or a combination thereof. The RRC signaling may also be referred to as an RRC message, for example, an RRC Connection Setup message, an RRC Connection Reconfiguration message, and the like.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, and the like of each aspect/embodiment described in the present disclosure may be changed in order as long as there is no contradiction. For example, the methods described in this disclosure use an exemplary sequence to present the elements of the various steps and are not limited to the particular sequence presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each of the aspects/embodiments described in the present disclosure may be used alone, in combination, or switched over in accordance with implementation. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channel and the symbol may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile body may be a vehicle (For example, cars, planes, etc.), an unmanned mobile body (Drones, self-driving cars, etc.), or a robot (manned or unmanned). At least one of a base station and a mobile station can be a device that does not necessarily move during the communication operation. For example, at least one of a base station and a mobile station may be an Internet of Things (IoT) device such as a sensor.

The base station in the present disclosure may be read as a mobile station (user terminal). For example, each aspect/embodiment of the present disclosure may be applied to a configuration in which communication between a base station and a mobile station is replaced with communication between a plurality of mobile stations (For example, it may be called Device-to-Device (D2D), Vehicle-to-Everything (V2X), etc.). In this case, the mobile station may have the function of the base station. In addition, words such as “up” and “down” may be replaced with words corresponding to communication between terminals (For example, “side”.). For example, terms an uplink channel, a downlink channel, or the like may be read as a side channel.

Similarly, the mobile station in the present disclosure may be read as a base station. In this case, the base station may have the function of the mobile station. A radio frame may be composed of one or more frames in the time domain. Each frame or frames in the time domain may be referred to as a subframe. A subframe may be further configured by one or more slots in the time domain. The subframe may be a fixed time length (For example, 1 ms) independent of the numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in time units greater than the minislot may be referred to as PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the sub-frame and TTI may be a sub-frame (1 ms) in the existing LTE, a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. The number of slots (minislot number) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB based on the common reference point of the carrier. PRB may be defined in BWP and numbered within that BWP.

BWP may include UL BWP (UL BWP) and DL BWP (DL BWP). One or a plurality of BWPs may be set in one carrier for the UE.

At least one of the configured BWPs may be active, and the UE may not expect to send and receive certain signals/channels outside the active BWP. Note that “cell”, “carrier”, and the like in this disclosure may be read as “BWP”.

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

The “means” in the configuration of each apparatus may be replaced with “unit”, “circuit”, “device”, and the like.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining” and “determining” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. That is, “judgment” or “decision” may include regarding some action as “judgment” or “decision”. Moreover, “judgment (decision) ” may be read as “assuming”, “expecting”, “considering”, and the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system
20 E-UTRAN
30 NG RAN
40 UPF
100A eNB
100B gNB
110 radio communication unit
120 RRC processing unit
130 DC processing unit
140 control unit
200 UE
210 radio communication unit
220 RRC processing unit
230 DC processing unit
240 control unit
1001 processor
1002 memory
1003 storage
1004 communication device
1005 input device
1006 output device
1007 bus

1. A terminal comprising:
a reception unit that receives a message including a reconfiguration instruction for a secondary cell group; and
a control unit that, when adding or changing a secondary cell while the secondary cell group is in an inactive state, even if reconfiguration of the secondary cell is executed based on the reconfiguration instruction, stops a random access procedure for a prescribed period of time.

2. A terminal comprising:
a reception unit that receives a message including a reconfiguration instruction for a secondary cell group; and
a control unit that, when adding or changing a secondary cell while the secondary cell group is in an inactive state, executes a random access procedure based on the reconfiguration instruction and maintains the secondary cell group in an inactive state.

3. A terminal comprising:
a reception unit that receives a message including a reconfiguration instruction for a secondary cell group; and
a control unit that, when adding or changing a secondary cell while the secondary cell group is an inactive state, executes only a part of the reconfiguration of the secondary cell based on the reconfiguration instruction and stops a random access procedure.

4. A terminal comprising:
a reception unit that receives a message including a reconfiguration instruction for a secondary cell group; and
a control unit that, when adding or changing a secondary cell while the secondary cell group is in an inactive state, if activation of the secondary cell group is required after receiving the reconfiguration instruction, executes reconfiguration of the secondary cell based on the reconfiguration instruction.

5. A Radio communication method comprising the steps of:
receiving, by a terminal, a message containing a reconfiguration instruction for a secondary cell group; and
when the terminal adds or changes a secondary cell while the secondary cell group is in an inactive state, even if the terminal executes reconfiguration of the secondary cell based on the reconfiguration instruction, stopping the random access procedure for a prescribed period of time.

6. A radio communication method comprising the steps of:
receiving, by a terminal, a message containing a reconfiguration instruction for a secondary cell group; and
when the terminal adds or changes a secondary cell while the secondary cell group is in an inactive state, executing only a part of the reconfiguration of the secondary cell based on the reconfiguration instruction and stopping the random access procedure.
